(19) United States
(12) Patent Application Publication
(10) Pub. No.: US 2015/0220917 A1
(43) Pub. Date: Aug. 6, 2015

(54) TOKEN VERIFICATION USING LIMITED USE CERTIFICATES

(71) Applicants: Christian Aabye, Foster City, CA (US); Brian Sullivan, Foster City, CA (US); Dave Wilson, Foster City, CA (US)

(72) Inventors: Christian Aabye, Foster City, CA (US); Brian Sullivan, Foster City, CA (US); Dave Wilson, Foster City, CA (US)

(21) Appl. No.: 14/614,315

(22) Filed: Feb. 4, 2015

Related U.S. Application Data
(60) Provisional application No. 61/935,625, filed on Feb. 4, 2014.

(51) Int. Cl. G06Q 20/36; G06Q 20/38; H04L 9/32

(52) U.S. Cl. CPC G06Q 20/3674; H04L 9/3247; H04L 9/3268; H04L 9/3234; G06Q 20/382

(57) ABSTRACT

Methods, devices, and systems are provided for verifying tokens using limited-use certificates. For example, a user device can send a token request to a token provider computer, and receive in response a token and a token certificate associated with the token. The token certificate may include, for example, a hash of the token and a digital signature by the token provider computer or another trusted entity. The user device can provide the token and the token certificate to an access device. The access device can verify the token using the token certificate, and verify the token certificate using a digital signature. In some cases, the token and token certificate may be verified offline. The access device can then conduct a transaction using the token.

### CROSS-REFERENCES TO RELATED APPLICATIONS

The present application is a non-provisional application of and claims priority to U.S. Provisional Application No. 61/935,625, filed on Feb. 4, 2014 (Attorney Docket No.: 79900-896871), the entire contents of which are hereby incorporated by reference for all purposes.

### BACKGROUND

Tokenization provides many advantages when conducting transactions, such as improving efficiency and security. However, in order to verify the authenticity of a token, a connection to a token server (e.g., a server that generated the token) may be required. Once a connection to the token server is made, the token may be checked for validity (e.g., to determine whether it may be used for a transaction, etc.). However, in many situations, such as when tokens are used in a mass transit system or at some merchant locations, an online connection to a token server to validate the token may be unavailable, or such an online connection may be too slow to accommodate the amount of transaction volume that takes place in a short amount of time.

Embodiments of the present invention address these problems and other problems individually and collectively.

### BRIEF SUMMARY

Embodiments of the invention relate to methods, devices, and systems for verifying tokens using limited-use certificates.

In some embodiments, a user device can send a token request to a token provider computer, and receive in response a token and a token certificate associated with the token. The token certificate may include, for example, a hash of the token and a digital signature by the token provider computer or another trusted entity. The user device can provide the token and the token certificate to an access device. The access device can verify the token using the token certificate, and verify the token certificate using a digital signature. In some cases, the token and token certificate may be verified offline. The access device can then conduct a transaction using the token.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 shows an example of a system that may be used with embodiments of the invention.

FIG. 2 shows an example of a user device in accordance with some embodiments.

FIG. 3 shows an example of an access device in accordance with some embodiments.

FIG. 4 shows an example of a token system in accordance with some embodiments.

FIG. 5 shows an example of a token certificate in accordance with some embodiments.

FIG. 6 shows a method of obtaining a token and a token certificate by a user device in accordance with some embodiments.

FIG. 7 shows a method of generating and provisioning a token by a token provider computer in accordance with some embodiments.

FIG. 8 shows a method of conducting a transaction by an access device using a token in accordance with some embodiments.

FIG. 9 shows a method of conducting a transit transaction using a token in accordance with some embodiments.

FIG. 10 shows an example of a portable user device.

FIG. 11 shows an example of a computer apparatus.

### TERMS

Prior to discussing embodiments of the invention, description of some terms may be helpful in understanding embodiments of the invention.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The term “public/private key pair” may include a pair of linked cryptographic keys generated by an entity. The public key may be used for public functions such as encrypting a message to send to the entity or for verifying a digital signature which was supposedly made by the entity. The private key, on the other hand may be used for private functions such as decrypting a received message or applying a digital signature. The public key will usually be authorized by a body known as a Certification Authority (CA) which stores the public key in a database and distributes it to any other entity which requests it. The private key will typically be kept in a secure storage medium and will usually only be known to the entity. However, the cryptographic systems described herein may feature key recovery mechanisms for recovering lost keys and avoiding data loss. Public and private keys may be in any suitable format, including those based on RSA or elliptic curve cryptography (ECC).

A “digital signature” may refer to the result of applying an algorithm based on a public/private key pair, which allows a signing party to manifest, and/or a verifying party to verify, the authenticity and/or integrity of a document. The signing party acts by means of the private key and the verifying party acts by means of the public key. This process certifies the authenticity of the sender, the integrity of the signed document and the so-called principle of nonrepudiation, which does not allow disowning what has been signed. A certificate or other data that includes a digital signature by a signing party is said to be “signed” by the signing party. In some embodiments, the digital signature may be performed in accordance with RSA public key cryptography.

A “certificate” may include an electronic document or data file that uses a digital signature to bind data (e.g., a token) with data associated with an identity. The certificate may include one or more data fields, such as the legal name of the identity, a serial number of the certificate, a valid-from and valid-to date for the certificate, certificate-related permissions, etc. A certificate may contain a “valid-from” date indicating the first date the certificate is valid, and a “valid-to” date indicating the last date the certificate is valid. A certificate may also contain a hash of data protected by the certificate including the data fields. The hash may include data contained within the certificate, and/or data that is not contained in the certificate. Hence, a hash can be used to enable the certificate to protect a data set that is larger than the certificate size (e.g., a hash of data fields in the certificate and additional data not contained in the certificate). In some embodiments, each certificate is signed by a certificate authority. In some embodiments, a certificate may be in any suitable format, such as those defined in Europay, MasterCard, and Visa (EMV) standard ISO 9796 and ITU-T standard X.509.

A “certificate authority” (CA) may include one or more server computers operatively coupled to issue certificates to entities. The CA may prove its identity using a CA certificate, which includes the CA's public key. The CA certificate may be signed by another CA's private key, or may be signed by the same CA's private key. The latter is known as a self-signed certificate. The CA also typically maintains a database of all certificates issued by the CA.

In some implementations, the certificate authority receives an unsigned certificate from an entity whose identity is known. The unsigned certificate includes a public key, one or more data fields, and a hash of the data in the certificate. The CA signs the certificate with a private key corresponding to the public key included on the CA certificate. The CA may then store the signed certificate in a database, and issue the signed certificate to the entity.

A “token” may include a number, string, bit sequence, and/or other data value intended to substitute for or represent account information associated with a user. In some embodiments, there may not be a need to substitute account information such as a primary account number (PAN) with a token—in which case, the account information or PAN can be used as the token. In some embodiments, the token may be derived from or directly related to a primary account number (PAN) or other payment account information (e.g., pseudo PAN, dynamic PAN, obfuscated PAN, partially encrypted PAN, etc.). In some embodiments, the token may include a randomly generated identifier that is associated with the user account.

A “token certificate” may include a digital certificate or other data that authenticates a token using a digital signature. The digital signature may be generated by a token provider or other authorized entity. In some cases, the token certificate may include a token identifier (e.g., a hash of the token), and the digital signature of the token certificate may be generated using the token identifier. The token certificate may also include other data defining the use of the token, such as an expiration date and a transaction context identifier.

A “token access restriction” may include a restriction or other limitation relating to the use of a token. A token access restriction may include, for example, a maximum transaction value, an expiration date for the token, and a transaction context for the token.

A “transaction context” may include any information relating to situations in which a token may be used. For example, a transaction context may indicate access devices or merchants at which the token is valid, dates and times during which the token is valid, etc. A “transaction context identifier” may include any data suitable to identify a transaction context.

A “transaction context” may include an indication of a context or system in which a token is valid. In some cases, the transaction context may indicate a provider or other system with which the token may be used. For example, a transaction context may indicate that a token is only valid for use with a particular transit provider.

### DETAILED DESCRIPTION

Embodiments of the invention relate to methods, devices, and systems for verifying tokens using limited-use certificates.

In some embodiments, a user device can send a token request to a token provider computer, and receive in response a token and a token certificate associated with the token. The token certificate may include, for example, a hash of the token and a digital signature by the token provider computer or another trusted entity. The user device can provide the token and the token certificate to an access device. The access device can verify the token using the token certificate, and verify the token certificate using a digital signature. In some cases, the token and token certificate may be verified offline. The access device can then conduct a transaction using the token.

Embodiments can provide systems and methods for conducting transaction using tokens without requiring a connection to a validating server. The use of tokens to conduct transactions provides several advantages. For example, since a token may identify an account without using an account number, tokens can be used to protect sensitive information and/or identity of a user from unscrupulous parties. In addition, tokens can be configured to be valid for limited periods of time, which limits the damage that may occur if the token is compromised.

In addition, by using a token certificate associated with token, embodiments can allow an access device, terminal, or other entity to determine access restrictions for the token. Further, since the token certificate may be signed by an issuer, certificate authority (CA), or other trusted party, the access device or terminal may cryptographically verify the authenticity of the token certificate without network connectivity. Thus, embodiments can allow access restrictions on tokens to be enforced in offline environments, or where a network connection is too slow relative to transaction volume. Furthermore, embodiments can allow token verification to performed faster and more efficiently, because processing time does not depend on network latency, bandwidth, or the speed of a remote token server.

### I. Systems

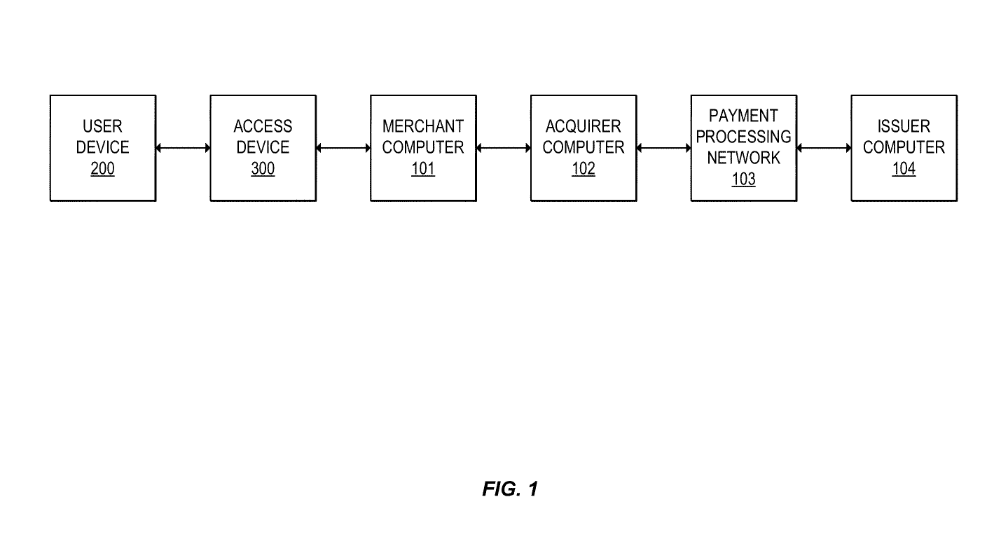

FIG. 1 shows an example of a system that may be used with embodiments of the invention. The system comprises a user (not shown) who may operate a user device 200. The user may use user device 200 to conduct transactions (e.g., payment transaction, access transaction, etc.) in communication with an access device 300. As used herein, a “user device” may include a mobile phone, tablet, credit card, debit card, or any other suitable device. In some cases, a user device may be a wearable device, such as a watch or smart watch, fitness band, ankle bracelet, ring, earring, etc. Access device 300 may be connected to merchant computer 101, which may be connected to acquirer computer 102. Acquirer computer 102 may be connected to issuer computer 104 via payment processing network 103.

As used herein, an “issuer” may typically refer to a business entity (e.g., a bank) that maintains an account for a user and may issue a user device 200 such as a credit or debit card to the user, or provision a user device 200 such as a mobile phone. An issuer may also issue a token and a token certificate to user device 200.

A “merchant” is typically an entity that engages in transactions and can sell goods or services, or provide access to goods or services. In some cases, the merchant may be associated with a transit provider or other access provider. In some cases, the issuer and merchant may be the same entity. For example, a transit provider may both maintain accounts for users and operate access devices 300 used to conduct transactions.

An “acquirer” is typically a business entity (e.g., a commercial bank) that has a business relationship with a particular merchant or other entity. Some entities can perform both issuer and acquirer functions. Some embodiments may encompass such single entity issuer-acquirers.

Each of the entities may comprise one or more computer apparatuses (e.g., access device 300, merchant computer 101, acquirer computer 102, payment processing network 103, and issuer computer 104) to enable communications, or to perform one or more of the functions described herein.

The payment processing network 103 may include data processing subsystems, networks, and operations used to support and deliver certificate authority services, authorization services, exception file services, transaction scoring services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 103 may include one or more server computers. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 103 may use any suitable wired or wireless network, including the Internet.

The user may conduct a transaction at a merchant using a user device 200. The transaction may be a payment transaction (e.g., for the purchase of a good or service), an access transaction (e.g., for access to a transit system), or any other suitable transaction. The user's user device 200 can interact with an access device 300 at a merchant associated with merchant computer 101. For example, the user may tap a portable user device 200 against an NFC reader in the access device 300. Alternately, the user may indicate account information to the merchant electronically, such as in an online transaction. In some cases, the user device 200 may transmit to the access device an account identifier, such as a token.

In some embodiments, an online authorization of the transaction may be performed directly after the user presents account information. In other embodiments, online authorization may be deferred until a later time. For example, in some embodiments, access device 300 or merchant computer 101 may verify user device 200 (e.g., by verifying the signature, validity of the certificate, and/or use restrictions such as time limits and/or purchase type restrictions included on a certificate) when user device 200 interfaces with access device 300 or merchant computer 101. Once user device 200 is verified, the user may receive and/or use goods or services, and/or be granted access to a location, etc., before the transaction is authorized online. Later, depending on various network access, processing time, or other constraints, an online authorization including an authorization request message may be conducted.

For example, a user may tap a user device 200 such as a contactless card at access device 300 on a bus when boarding the bus. Access device 300 may verify user device 200 by verifying a certificate and access restrictions on user device 200. Once the user device 200 is verified, the user may board the bus without requiring an online authorization of the transaction. Later, when the bus reaches a bus terminal, access device 300 may gain wireless connectivity and initiate online authorization for the user's transaction.

In order to perform online authorization for a transaction, an authorization request message may be generated by access device 300 or merchant computer 101 and then forwarded to the acquirer computer 102. After receiving the authorization request message, the authorization request message is then sent to the payment processing network 103. The payment processing network 103 then forwards the authorization request message to the corresponding issuer computer 104 associated with an issuer associated with the user device 200.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

After the issuer computer 104 receives the authorization request message, the issuer computer 104 sends an authorization response message back to the payment processing network 103 to indicate whether the current transaction is authorized (or not authorized). The payment processing network 103 then forwards the authorization response message back to the acquirer computer 102. In some embodiments, payment processing network 103 may decline the transaction even if issuer computer 104 has authorized the transaction, for example depending on a value of the fraud risk score. The acquirer computer 102 then sends the response message back to the merchant computer 101.

An “authorization response message” may be an electronic message reply to an authorization request message generated by an issuing financial institution 104 or a payment processing network 103. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network 103) to the merchant computer 101 that indicates approval of the transaction. The code may serve as proof of authorization. As noted above, in some embodiments, a payment processing network 103 may generate or forward the authorization response message to the merchant.

After the merchant computer 101 receives the authorization response message, the merchant computer 101 may then provide the authorization response message for the user. The response message may be displayed by the access device 300, or may be printed out on a physical receipt. Alternately, if the transaction is an online transaction, the merchant may provide a web page or other indication of the authorization response message as a virtual receipt. The receipts may include transaction data for the transaction.

At the end of the day, a normal clearing and settlement process can be conducted by the payment processing network 103. A clearing process is a process of exchanging financial details between an acquirer and an issuer to facilitate posting to a customer's payment account and reconciliation of the user's settlement position.

A. User Device

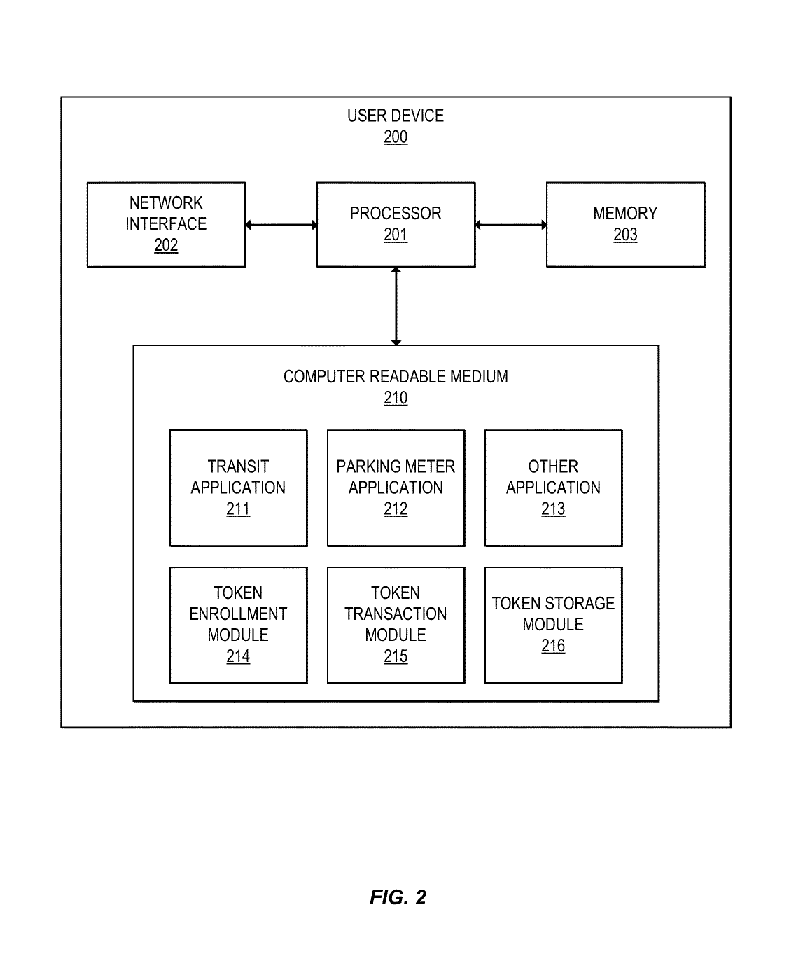

FIG. 2 shows an example of a user device 200 in accordance with some embodiments. Examples of user devices 200 may include mobile phones, tablets, desktop and laptop computers, wearable devices (e.g., smart watches, fitness bands, ankle bracelets, rings, earrings, etc.), or any other computing device suitable for receiving, storing, and transmitting tokens. User device 200 may include a processor 201 communicatively coupled to a network interface 202, a memory 203, and a computer readable medium 210.

The processor 201 can comprise one or more CPUs, each of which may comprise at least one processor cores operable to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. In some cases, processor 201 can include multiple CPUs coupled over a network, such as in a distributed or cluster computing system.

The network interface 202 may be configured to allow user device 200 to communicate with other entities such as access device 300, issuer computer 104, etc. using one or more communications networks. Network interfaces may accept, communicate, and/or connect to a communications network. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); a secured custom connection; a Wide Area Network (WAN); a wireless network (e.g., employing protocols such as, but not limited to a Wireless Application Protocol (WAP), I-mode, and/or the like); and/or the like.

The memory 203 may be used to store data and code. The memory 203 may be coupled to the processor 201 internally or externally (e.g., cloud based data storage), and may comprise any combination of volatile and/or non-volatile memory, such as RAM, DRAM, ROM, flash, or any other suitable memory device.

The computer-readable medium 210 may be in the form of a memory (e.g., flash, ROM, etc.) and may comprise code, executable by the processor 201 for implementing the methods described herein. The computer readable medium 210 may include a transit application 211, a parking meter application 212, another application 213, a token enrollment module 214, a token transaction module 215, and a token storage module 216.

Transit application 211 may include any program, app, software, or other code suitable to conduct transactions with a transit provider. In some embodiments, transit application 211 may be specific to a single transit provider or a group of transit providers. Alternatively, transit application 211 can be general purpose, such as a web browser that accesses a transit provider's website. Transit application 211 may include a user interface to browse for and select transit services to be purchased, and to conduct transit transactions. For example, a user may use transit application 211 to purchase one-way or round-trip tickets, fixed duration or value passes, and other goods. Transit application 211 may determine a cost of the goods to be purchased, obtain a token corresponding to the purchased goods and a token certificate corresponding to the token, and send the token and token certificate to an access device in order to conduct a transaction (e.g., pay a fare or provide proof of payment of the fare).

Parking meter application 212 may include any program, app, software, or other code suitable to conduct transactions with a parking provider. In some embodiments, parking meter application 212 may be specific to a parking provider or a group of parking providers. Alternatively, parking meter application 212 can be general purpose, such as a web browser that accesses a parking provider's website. Parking meter application 211 may include a user interface to browse for and select parking spaces to be purchased, and to pay for the parking spaces. For example, a user may use parking meter application 212 to purchase a certain duration of parking, parking permits, and other goods. Parking meter application 211 may determine a cost of the goods to be purchased, obtain a token corresponding to the purchased goods and a token certificate corresponding to the token, and send the token and token certificate to an access device in order to conduct a transaction (e.g., pay for parking or provide proof of payment).

Other application 213 may include any program, app, software, or other code suitable to conduct any other type of transaction. In some embodiments, parking meter application 212 may be specific to a parking provider or a group of parking providers. For example, other application 213 may be configured to determine goods or services for a transaction, obtain a token and token certificate, and use the token and token certificate to pay for the goods or services at an access device (e.g., access device 300).

Token enrollment module 214 may include any program, software, or other code suitable to enroll a user device with a token provider (e.g., token provider computer 401). For example, in some embodiments, token enrollment module 214 may be configured to communicate with a token provider computer to send a token request. The token request may include account information, such as a primary account number (PAN). In response, token enrollment module 214 may receive a token and a token certificate corresponding to the token. The token and/or the token certificate may be stored in token storage module 216. In some embodiments, an application, such as applications 211-213 may interface with token enrollment module 214 to obtain a token and a token certificate from a token provider.

Token transaction module 215 may include any program, software, or other code suitable to conduct or initiate a transaction using a token. For example, token transaction module 215 may be configured to retrieve a token and a token certificate, provide the token and token certificate to an access device (e.g., access device 300) for a transaction, and receive a response from the access device indicating the status of the transaction. In some embodiments, an application, such as applications 211-213 may interface with token transaction module 215 to conduct a transaction using a token. For example, in one embodiment, a transit application may determine that user device 200 has moved near a contactless reader of an access device, determine an appropriate context and token (or just token), and interface with token transaction module 215 to provide the corresponding token and token certificate to the access device.

Token storage module 216 may include any software and/or hardware suitable to store tokens and/or token certificates. Typically, token storage module 216 may be secured, so that unauthorized entities (such as other programs running on user device 200) cannot access the stored token. In some embodiments, the security of token storage module 216 may be provided in software, such as through host card emulation (HCE). In other embodiments, the security of token storage module 216 may be provided through hardware, such as a hardware security module (HSM), secure element, trusted execution environment (TEE), etc. In yet other embodiments, the security of token storage module 216 may use a combination of software and hardware.

Although FIG. 2 illustrates one example of a user device 200, it should be noted that embodiments are not limited to the shown device. Rather, a user device in accordance with embodiments may be missing one or more elements shown in FIG. 2, and may include other elements not shown. For example, embodiments are not limited to transit applications or parking meter applications.

B. Access Device

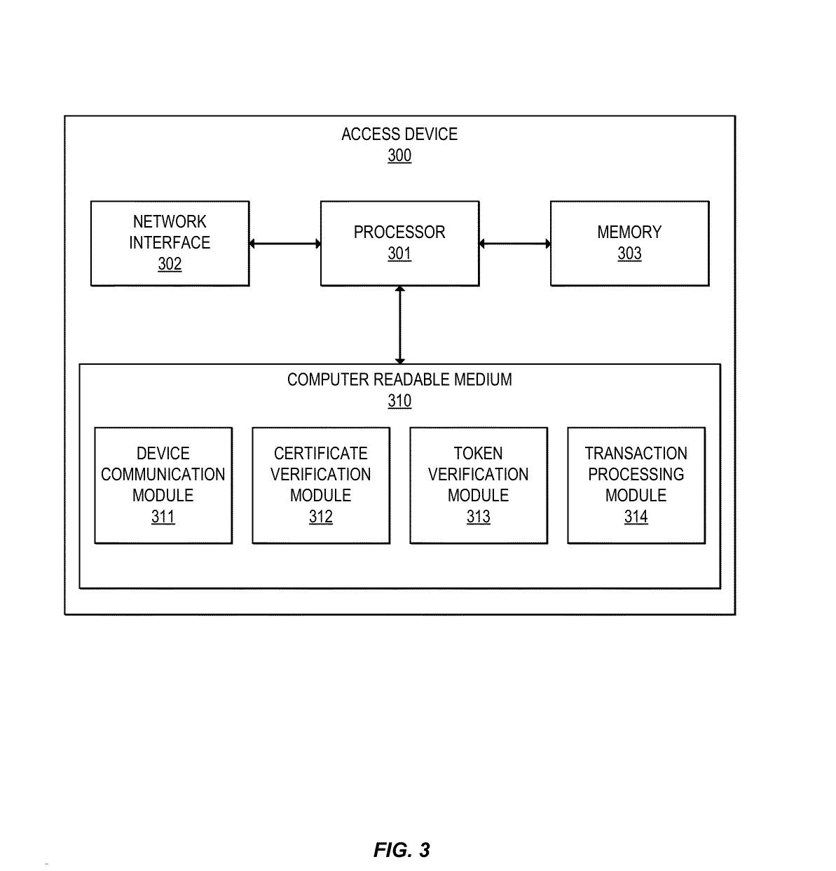

FIG. 3 shows an example of an access device 300 in accordance with some embodiments. Examples of access devices 200 may include mobile devices (e.g., mobile phones, tablets, wearable devices), desktop or laptop computers, point of sale (POS) terminals, or any other computing device suitable for receiving and conducting transactions using tokens. Access device 300 may include a processor 301 communicatively coupled to a network interface 302, a memory 303, and a computer readable medium 310. In some embodiments, processor 301, network interface 302, memory 303, and computer-readable medium 310 may be similar to the corresponding elements as described with reference to user device 200 of FIG. 2.

The computer readable medium 310 may include a device communication module 311, a certificate verification module 212, a token verification module 313, and a transaction processing module 314.

Device communication module 311 may include any software and/or hardware configured to communicate with user devices, such as user device 200. For example, in some embodiments, access device 300 may communicate using a contactless or wireless protocol, such as NFC or PayWave™. In such embodiments, device communication module 311 may include a contactless transceiver and firmware or other software configured to send signals to and receive signals from user devices. In some embodiments, device communication module 311 may be configured to receive a token and a token certificate from a user device in one or more messages.

Certificate verification module 312 may include any software and/or hardware configured to verify digital certificates, such as token certificates. For example, in some embodiments, certificate verification module 312 may include code operable to verify a digital signature included in a token certificate. In some embodiments, verifying the digital signature may include decrypting the digital signature using a trusted entity's public key and comparing the result to an expected value. The expected value may be, for example, a hash of part or all of the certificate. In some embodiments, certificate verification module 312 may maintain one or more trusted certificates and/or trusted public keys corresponding to trusted entities, such as token providers. If a token certificate is signed by one of the stored trusted certificates or trusted public keys, then the token certificate may be verified offline (i.e., without any communication with other devices). In some embodiments, some or all of the functionality of certificate verification module 312 may be performed by dedicated hardware such as an HSM or cryptoproccessor.

Token verification module 313 may include any program, software, or other code suitable to verify the legitimacy and the use of a token. Typically, token verification module 313 may verify a token using data included in a valid token certificate. For example, in some cases, a token certificate may include a token identifier such as a hash of the token. In such cases, verifying the token may include ensuring a hash of the token matches the token identifier of the token certificate. In some embodiments, a token certificate may also include a context identifier. In such embodiments, verifying the token may include verifying that the token is being used in an appropriate context. For example, a token certificate may indicate that a token is only valid for use at a transit provider. Token verification module 313 can then ensure that access device 300 is associated with the transit provider. If the check fails, the token may be rejected as being used in the wrong context (i.e., it may be unauthorized).

Transaction processing module 314 may include any program, software, or other code suitable to conduct or initiate a transaction using a token. For example, transaction processing module 314 may be configured to generate and send an authorization request message for a transaction (e.g., as described with reference to FIG. 1) including a received token. Transaction processing module 314 may also receive and process an authorization response message indicating the status of the transaction. In some embodiments, transaction processing may occur some time after a token has been verified (e.g., by token verification module 313). For example, if access device 300 is on a city bus that does not have a persistent network connection, authorization for a transaction may not be performed until the end of the day when the bus returns to a bus terminal with wireless internet access.

Although FIG. 3 illustrates one example of an access device 300, it should be noted that embodiments are not limited to the shown device. Rather, an access device in accordance with embodiments may be missing one or more elements shown in FIG. 3, and may include other elements not shown.

Although FIG. 3 illustrates one example of an access device 300, it should be noted that embodiments are not limited to the shown device. Rather, an access device in accordance with embodiments may be missing one or more elements shown in FIG. 3, and may include other elements not shown.

C. Token System

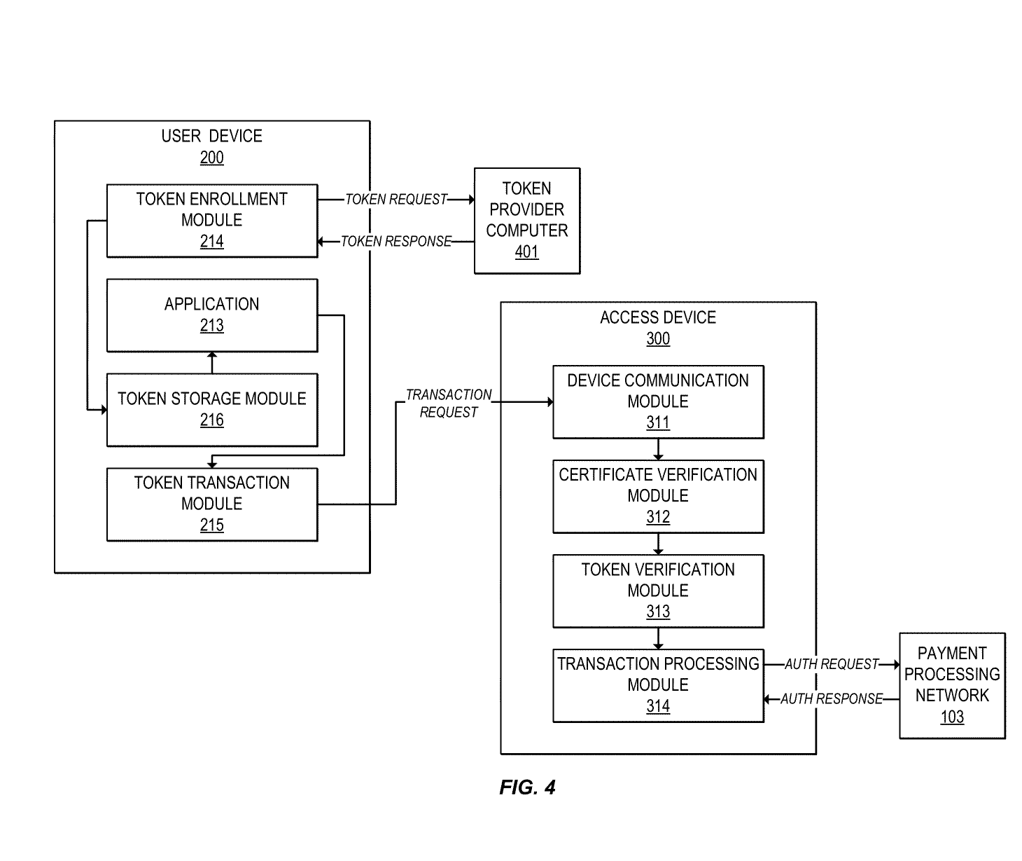

FIG. 4 shows an example of a token system in accordance with some embodiments. As shown in FIG. 4, the token system includes user device 200 (as further described with reference to FIG. 2), access device 300 (as further described with reference to FIG. 3), payment processing network 103 (as further described with reference to FIG. 1), and a token provider computer 401.

Token provider computer 401 may comprise any server computer suitable to associate account information with tokens. For example, in some embodiments, token provider computer may be configured to receive a token request including account information, authenticate and authorize the token request, generate a token, associate the token with the account corresponding to the received account information, and return a token response including the token. In some embodiments, the token response may also include a token certificate corresponding to the token.

In some embodiments, token provider computer 401 may be operated by, on behalf of, or otherwise associated with another entity. For example, in some embodiments, token provider computer 401 may be operated by issuer computer 104 of an account.

In one embodiment, token enrollment module 214 of user device 200 sends a token request to token provider computer 401. The token request may include, for example, account information for a user account, and user credentials (e.g., a username and password). In response, token provider computer 401 returns a token response including a token and a token certificate to token enrollment module 214. Token enrollment module 214 stores the token in token storage module 216.

At a later time, a user may present user device 200 to access device 300 in order to conduct a transaction. For example, the user may operate an application 213 running on the user device. Application 213 may retrieve the token and the token certificate from token storage module 216. Application 213 then interfaces with token transaction module 215 to initiate a transaction with access device 300. Token transaction module 215 sends a transaction request including the token and the token certificate to device communication module 311 of access device 300.

Once device communication module 311 receives the transaction request, it forwards the token certificate to certificate verification module 312 for verification. If the token certificate is verified, token verification module 313 verifies the token. Once both the token certificate and the token are verified, access device 300 may provide an indication of the verification. For example, access device 300 may grant access to a location, or may actuate a restriction mechanism (e.g., a gate or a turnstile) that allows the user access. At a later time, transaction processing module 314 conducts a transaction using the token. For example, transaction processing module 314 generates and sends an authorization request message to payment processing network 103. Payment processing network 103 determines if the transaction is authorized or declined, and sends an authorization response message to transaction processing module 314. Transaction processing module 314 may then indicate (e.g., display) the status of the transaction.

D. Token Certificate

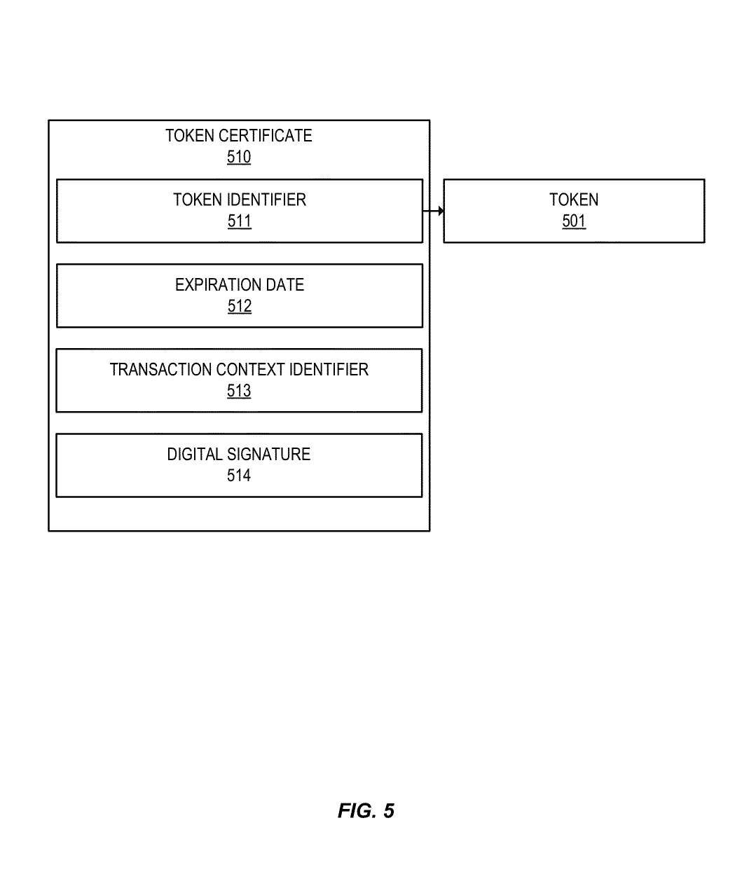

FIG. 5 shows an example of a token certificate 510 in accordance with some embodiments. In some cases, a token 501 may be issued to user device 200 by a token provider computer 401. As shown in FIG. 5, the token certificate 510 may comprise a token identifier 511, an expiration date 512, a transaction context identifier 513, and a digital signature 205.

Token identifier 511 may include any data suitable to identify a token. In some cases, the token identifier 511 may be the token 501 itself. In other cases, the token identifier 511 may store a protected form of the token 501. For example, token identifier 511 may store a cryptographic hash of the token 501.

Expiration date 512 may include any data suitable to define an expiration date associated with the token. Expiration date 512 may indicate, for example, the last day, month, and year on which the token may be used. Expiration date 512 may be stored in any suitable form, such as a UTC timestamp. In some embodiments, expiration date 512 may include a two-digit expiration day for the token.

Transaction context identifier 513 may include any data suitable to identify a transaction context for a token. For example, if a token may only be used at a mass transit provider, the transaction context may include an identifier for the transit provider. Transaction context identifier 513 may be used, for example, to prevent a payment token from being used at a transit terminal, and to prevent a transit token from being used at a non-transit merchant's point of sale terminal. In some embodiments, transaction context identifier 513 may be used to limit access to a particular transit provider, transit type (e.g., bus, rail, etc.), or be used to limit purchases to a particular merchant or product/service type (e.g., meals, clothing, etc.).

In some embodiments where the token certificate 510 comprises a bank identification number (BIN) field, the transaction context identifier 510 may be included in the BIN. For example, the BIN field may comprise six digits for a token BIN, and two or more digits for a transit provider identifier associated with the token 501.

Digital signature 514 may include a digital signature by a certificate authority (CA), signatory party, or other trusted entity. For example, in some embodiments, digital signature 514 may be generated by a token provider computer 401, an issuer computer 104, or a payment processing network 103. In some embodiments, the trusted entity used to sign the token certificate 510 may be identified using a public key index (PKI) specific to token certificates.

In some embodiments the usage of a public key index that is specific to token certificates may be used to impose restrictions similar to those described above for transaction context identifier 513. For example, the public key index may be used to prevent a payment token from being used at a transit terminal, and to prevent a transit token from being used at a non-transit merchant's point of sale terminal.

### II. Methods

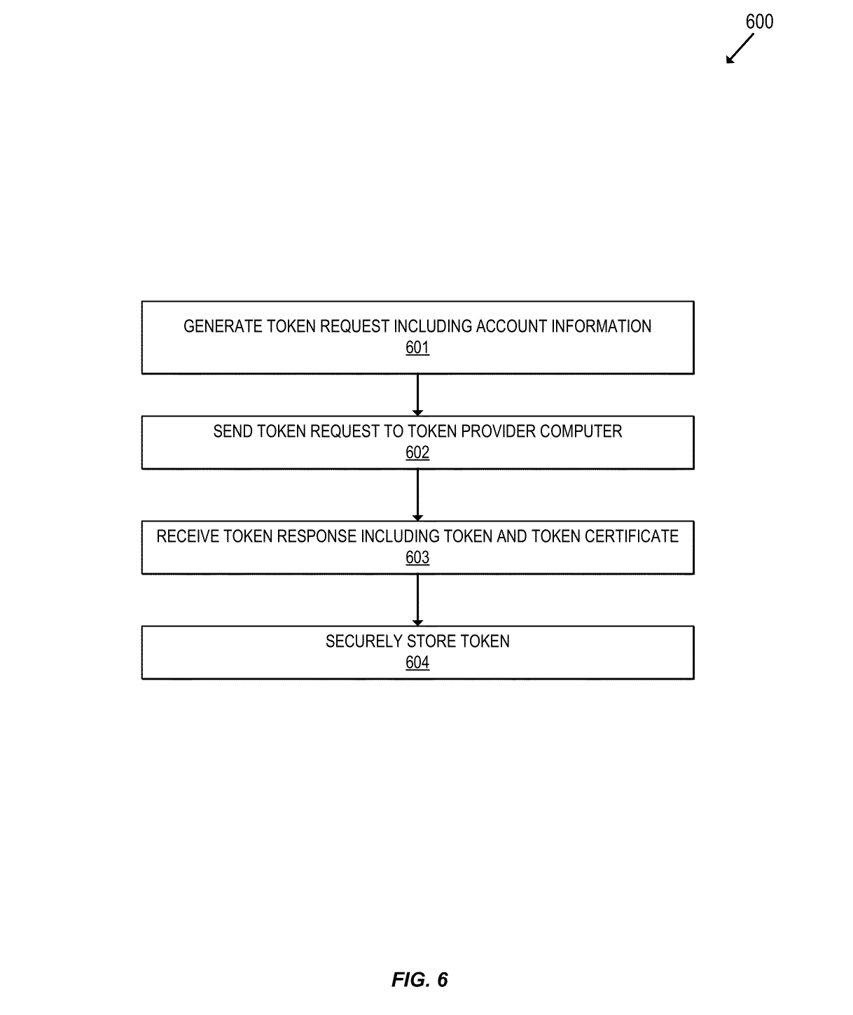

FIGS. 6-8 show methods of generating and obtaining a token and a token certificate, and using the token and token certificate to conduct a transaction.

A. User Device Obtaining Token Certificate

FIG. 6 shows a method 600 of obtaining a token and a token certificate in accordance with some embodiments. Typically, method 600 may be performed by a user device, such as user device 200, which can request a token from token provider computer 401, as shown in FIG. 4. However, in some embodiments, some or all of the described steps may be performed by other entities.

At step 601, a token request including account information is generated. Account information may include any data sufficient for identifying a user account. For example, in some embodiments, a user operating the user device may enter a username and password, an account number, and/or other account information. Alternatively, the account information may be received from another device, or may have been previously stored on user device 200. In some embodiments, the token request may also indicate a transaction context or other data to be associated with the requested token.

At step 602, the token request is sent to the token provider computer. In some embodiments, the appropriate token provider computer to direct the token request to may depend on the account information and/or the application (e.g., transit application 211, parking meter application 212, or other application 213) used to send the token request.

At step 603, a token response including a token and a token certificate is received from the token provider computer. The token may include a number, string, bit sequence, and/or other data value intended to substitute for or represent account information associated with a user. In some embodiments, there may not be a need to substitute account information such as a primary account number (PAN) with a token—in which case, the account information or PAN can be used as the token. In some embodiments, the token may be derived from or directly related to a primary account number (PAN) or other payment account information (e.g., pseudo PAN, dynamic PAN, obfuscated PAN, partially encrypted PAN, etc.). In some embodiments, the token may include a randomly generated identifier that is associated with the user account.

The token certificate may include a digital certificate or other data that authenticates a token using a digital signature. The digital signature may be generated by a token provider or other authorized entity. In some cases, the token certificate may include a token identifier (e.g., a hash of the token), and the digital signature of the token certificate may be generated using the token identifier. The token certificate may also include other data defining the use of the token, such as an expiration date and a transaction context identifier.

At step 604, the token is securely stored. In some embodiments, securely storing the token may include storing the token in token storage module 216.

It should be noted that although method 600 is described for illustrative purposes, in some embodiments other methods may be used to obtain a token and token certificate. For example, in some embodiments, step 601 may be performed by another entity, or may not be necessary. For example, a token may be requested by a desktop computer or other computing device. The token provider computer may then send the token and token certificate to the user device without requiring that the token request was received from user device 200. In some embodiments, the token and token certificate may be provisioned onto the user device 200 at the time of manufacture.

B. Token Provider Generating Token Certificate

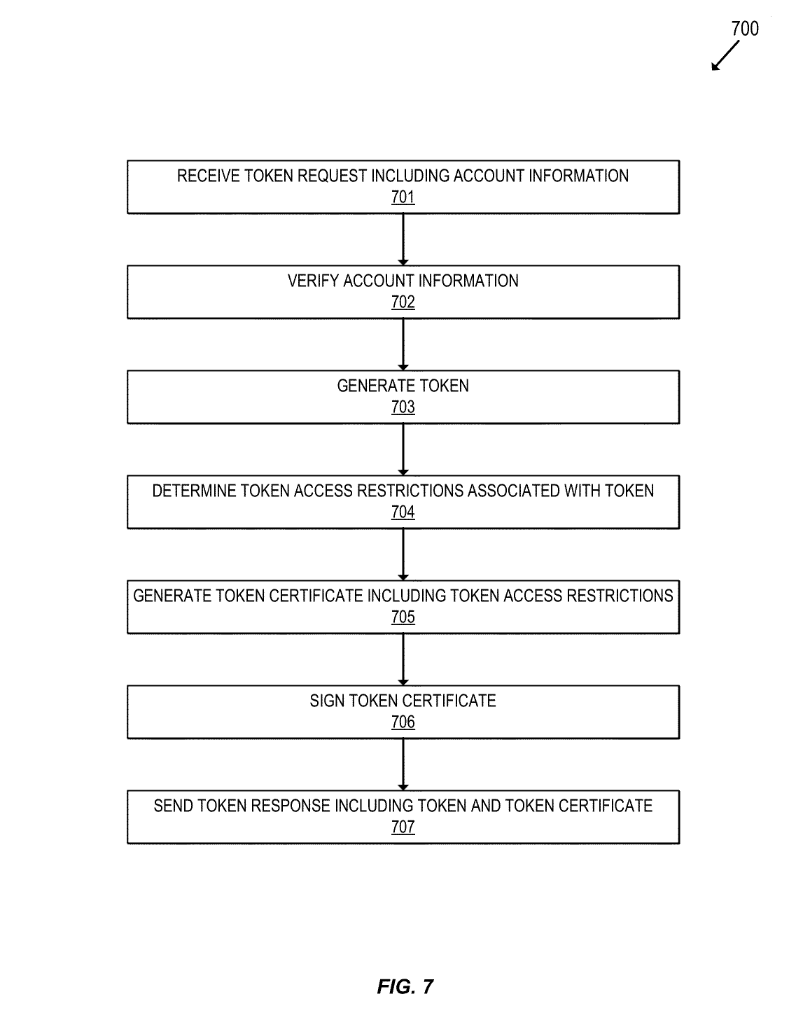

FIG. 7 shows a method of generating and provisioning a token in accordance with some embodiments. Typically, method 700 may be performed by a token provider computer, such as token provider computer 401. However, in some embodiments, some or all of the described steps may be performed by other entities, such as merchant computer 101, payment processing network 103, and issuer computer 104.

At step 701, a token request is received including account information for a user's account. The received account information may include any data sufficient for identifying a user account. For example, in some embodiments, the account information may include a username and password, an account number, and/or other account information. In some embodiments, the token request may also include a transaction context or other data to be associated with the requested token.

At step 702, the account information is verified. For example, if the account information includes a username and password, verifying the account information may comprise verifying that the password matches a stored password (or password hash) for the username. In addition, in some embodiments, verifying the account information may include ensuring that the account is authorized to request tokens.

At step 703, a token is generated. The token may be generated in any suitable manner. For example, the token may be generated randomly or pseudo-randomly, or may be generated using a deterministic algorithm. Once the token is generated, it may be associated with the user's account. For example, the token may be stored in a database mapping the token to an account number.

At step 704, token access restrictions associated with the token are determined. The token access restrictions may include any restriction or other limitation relating to the use of a token. A token access restriction may include, for example, a maximum transaction value, an expiration date for the token, and a transaction context for the token. In some embodiments, the token access restrictions may be determined based data relating to the user's account. For example, the issuer of the user's account, a credit score or security level associated with the user's account, and any access restriction data included in the token request may influence the determined token access restrictions.

At step 705, a token certificate is generated using the determined token access restrictions. The token certificate may include a a token identifier (e.g., a hash of the token), and other data defining the use of the token, such as an expiration date, a transaction context identifier, or other access restrictions.

At step 706, the token certificate is signed. Signing the token certificate may involve hashing some or all of the contents of the token certificate. The resulting hash may then be encrypted using a private key of a trusted entity, such as a token provider, payment processing network, or issuer, to generate a digital signature. The digital signature may then be included in the token certificate. In other embodiments, algorithms such as the Digital Signature Algorithm (DSA) and the Elliptic-Curve Digital Signature Algorithm (ECDSA) may be used.

At step 707, a token response is transmitted to the user device including the token and the signed token certificate. In various embodiments, the token can be transmitted separately from the signed token certificate or in a same message.

C. Access Device Conducting Transaction

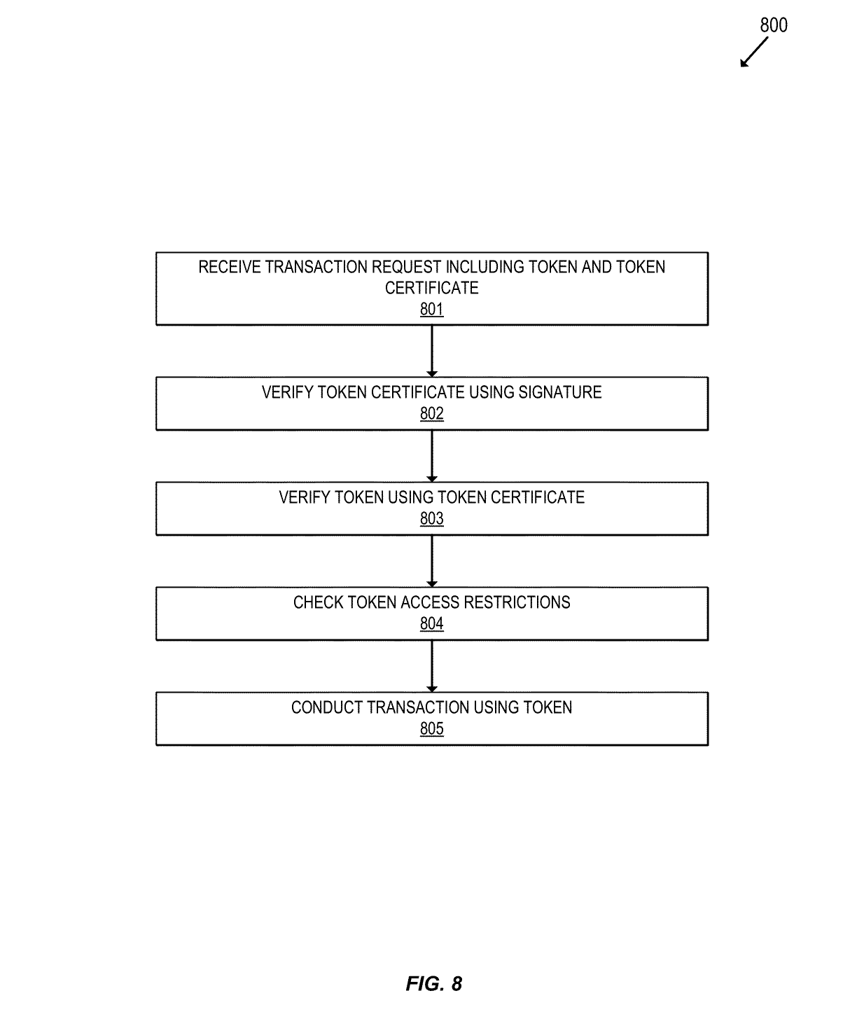

FIG. 8 shows a method of conducting a transaction using a token in accordance with some embodiments. Typically, method 800 may be performed by an access device, such as access device 300. However, in some embodiments, some or all of the described steps may be performed by other entities, such as merchant computer 101, payment processing network 103, or issuer computer 104.

At step 801, a transaction request is received including a token and a token certificate. The token may include a number, string, bit sequence, and/or other data value intended to substitute for or represent account information associated with a user. In some embodiments, there may not be a need to substitute account information such as a primary account number (PAN) with a token—in which case, the account information or PAN can be used as the token. In some embodiments, the token may be derived from or directly related to a primary account number (PAN) or other payment account information (e.g., pseudo PAN, dynamic PAN, obfuscated PAN, partially encrypted PAN, etc.). In some embodiments, the token may include a randomly generated identifier that is associated with the user account.

The token certificate may include a digital certificate or other data that authenticates a token using a digital signature. The digital signature may be generated by a token provider or other authorized entity. In some cases, the token certificate may include a token identifier (e.g., a hash of the token), and the digital signature of the token certificate may be generated using the token identifier. The token certificate may also include other data defining the use of the token, such as an expiration date and a transaction context identifier.

In addition, in some embodiments, the transaction request may include other data, such as goods or services to be purchased, an amount of the transaction, information regarding the user, etc. For example, in transit transactions, the transaction request may indicate a fare to be paid.

At step 802, the token certificate is verified using a digital signature included in the certificate. In some embodiments, verifying the digital signature may include decrypting the digital signature using a trusted entity's public key and comparing the result to an expected value. The expected value may be, for example, a hash of part or all of the certificate. In some embodiments, one or more trusted certificates and/or trusted public keys corresponding to trusted entities may be maintained. If a token certificate is signed by one of the stored trusted certificates or trusted public keys, then the token certificate may be verified offline (i.e., without any communication with other devices).

At step 803, the token is verified using the token certificate. For example, in some embodiments, a token certificate may include a token identifier such as a hash of the token. In such cases, verifying the token may include ensuring a hash of the token matches the token identifier of the token certificate.

At step 804, token access restrictions included in the token certificate are checked. For example, in some embodiments, a token certificate may include a transaction context identifier. In such embodiments, verifying the token may include verifying that the token is being used in an appropriate context. For example, a token certificate may indicate that a token is only valid for use at a transit provider. An access device or other entity performing step 804 can then confirm that the entity is associated with the transit provider. If the check fails, the token may be rejected as being used in the wrong context (i.e., it may be unauthorized). Other token access restrictions, such as restrictions on the date or time of use, may also be checked at step 804.

If the token access restrictions are satisfied, any goods or services associated with the token or a transaction are provided. For example, if the access device is a terminal on a bus, the access device may beep or provide another indication that the user is authorized to board the bus. In another example, if the access device is a parking meter, the parking meter may display an amount of time for which the spot is reserved. In some cases, once the token access restrictions are verified, the access device may actuate a restriction mechanism (such as a gate or turnstile) to allow a user access to a location.

At step 805, a transaction is conducted using the token. Conducting the transaction may include, for example, ensuring that a user's account has been billed for goods or services provided. For example, in some embodiments, conducting a transaction may comprise sending an authorization request message for a transaction (e.g., as described with reference to FIG. 1) including the received token. Transaction processing module 314 may also receive and process an authorization response message indicating the status of the transaction. In some embodiments, transaction processing may occur after a token has been verified at step 804.

D. Example Transit Transaction

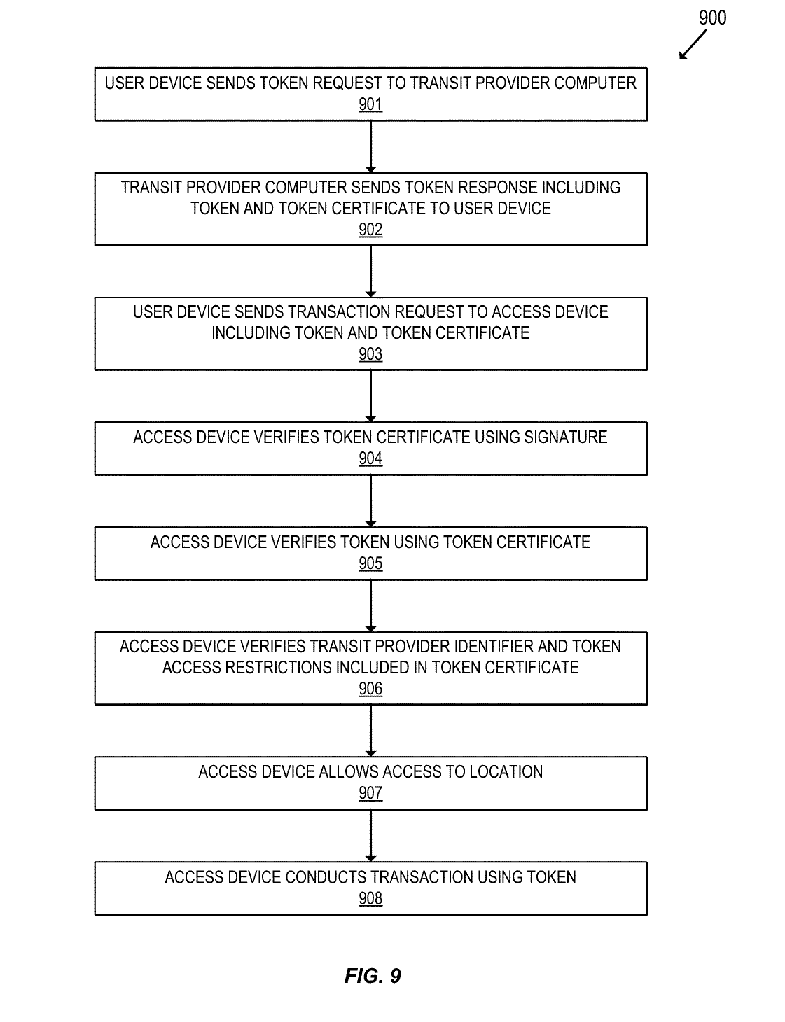

FIG. 9 shows a method 900 of conducting a transit transaction using a token in accordance with some embodiments of the invention. The steps in the method may be performed by a user device (e.g., user device 200), an access device (e.g., access device 300), a transit provider computer (e.g., payment processing network 103 or issuer computer 104), or any other suitable entity.

At step 901, a user device sends a token request to a transit provider computer. A transit provider computer may include any server computer associated with a transit provider. In some embodiments, in addition to account data for a transit account, the token request may include information relating to the user, such as any special statuses (e.g., child, senior, disabled) that the user qualifies for. In some embodiments, the token restrictions may be tied to differential pricing (e.g., a senior discount).

At step 902, the transit provider computer sends a token response to the user device. The token response includes a token and a token certificate. The token certificate may include a token identifier that is a hash of the token, and access restrictions such as a transit provider identifier and any special statuses for the user.

At step 903, the user device sends a transaction request to an access device. The transaction request includes the token and the token certificate. For example, if the access device is a contactless reader on a bus, the user may wave the user device past the contactless reader.

Alternatively, if the access device is connected to a turnstile, gate, or other access restriction mechanism, the user may similarly present the user device to the access restriction mechanism. In another example, if the access device is a handheld reader operated by a conductor, ticket inspector, or other personnel, then the user device may be presented to the access device.

At step 904, the access device verifies the token certificate using the digital signature. In some embodiments, the token certificate may be verified in a similar manner as described with reference to step 802 of FIG. 8.

At step 905, the access device verifies the token using the token certificate. In some embodiments, the token certificate may be verified in a similar manner as described with reference to step 803 of FIG. 8.

At step 906, the access device verifies the transit provider identifier and the token access restrictions included in the token certificate. For example, the access device can verify that it is associated with a transit provider corresponding to the transit provider identifier, that any time or date restrictions are met, etc. In addition, in some embodiments, the access device may receive confirmation from an operator that to determine that access restrictions are met. For example, if the token certificate indicates that the token is for a senior, a ticket inspector may confirm that the user is actually a senior.

At step 907, if verification steps 904-906 are completed successfully, the access device may allow access to a location. For example, if the access device is connected to a restriction mechanism (e.g., a gate or turnstile), the access device may send a signal to actuate the restriction mechanism.

At step 908, the access device conducts a transaction using the token. In some embodiments, the transaction may occur a period of time after step 907. For example, in some embodiments, transactions conducted at the access device may be processed on an hourly, daily, or otherwise asynchronous basis. In some embodiments, conducting a transit transaction may involve sending a message (e.g., an authorization request message) including the token to a transit provider computer. The transit provider computer may then determine a user account associated with the token, and debit or credit a corresponding amount from the user account. In some embodiments, the access device and/or the transit provider computer may determine an amount for the transaction based on the token certificate. For example, if the token certificate indicates that the user is a senior, the access device and/or the transit provider computer may calculate a transaction amount after a senior discount is applied.

### III. Computer Apparatuses

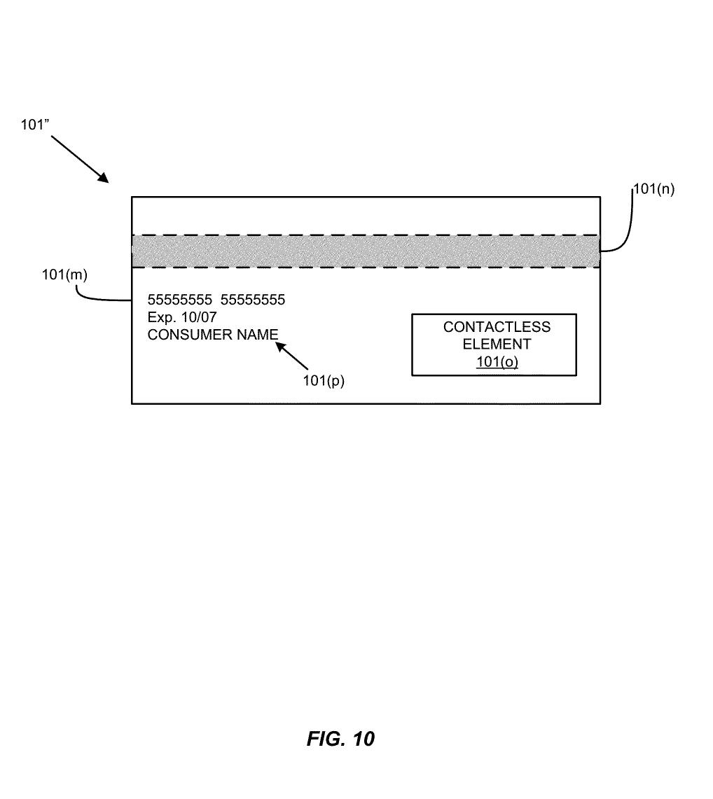

FIG. 10 shows an example of a portable user device 101″ in the form of a card. As shown, the portable user device 101″ comprises a plastic substrate 101(m). In some embodiments, a contactless element 101(o) for interfacing with an access device 102 may be present on, or embedded within, the plastic substrate 101(m). User information 101(p) such as an account number, expiration date, and/or a user name may be printed or embossed on the card. A magnetic stripe 101(n) may also be on the plastic substrate 101(m). In some embodiments, the portable user device 101″ may comprise a microprocessor and/or memory chips with user data stored in them.

As noted above and shown in FIG. 10, the portable user device 101″ may include both a magnetic stripe 101(n) and a contactless element 101(o). In some embodiments, both the magnetic stripe 101(n) and the contactless element 101(o) may be in the portable user device 101″. In some embodiments, either the magnetic stripe 101(n) or the contactless element 101(o) may be present in the portable user device 101″.

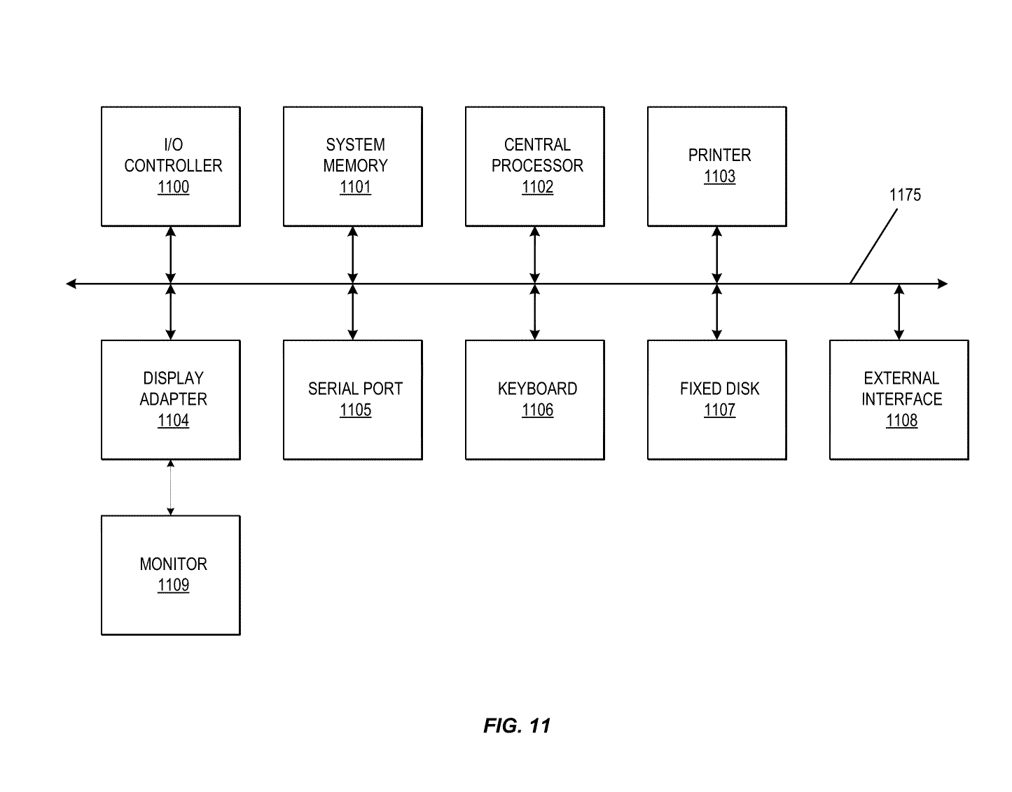

FIG. 11 is a high level block diagram of a computer system that may be used to implement any of the entities or components described above. The subsystems shown in FIG. 11 are interconnected via a system bus 1175. Additional subsystems include a printer 1103, keyboard 1106, fixed disk 1107, and monitor 1109, which is coupled to display adapter 1104. Peripherals and input/output (I/O) devices, which couple to I/O controller 1100, can be connected to the computer system by any number of means known in the art, such as a serial port. For example, serial port 1105 or external interface 1108 can be used to connect the computer apparatus to a wide area network such as the Internet, a mouse input device, or a scanner. The interconnection via system bus 1175 allows the central processor 1102 to communicate with each subsystem and to control the execution of instructions from system memory 1101 or the fixed disk 1107, as well as the exchange of information between subsystems. The system memory 1101 and/or the fixed disk may embody a computer-readable medium.

Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A computer-implemented method comprising:
receiving, by an access device, a token and a token certificate associated with the token from a user device, wherein the token certificate comprises a token identifier and a digital signature generated using the token identifier;
determining, by the access device, that the token certificate is valid by verifying that the digital signature corresponds to the token identifier;
determining, by the access device, that the token is valid using the token certificate; and
conducting, by the access device, a transaction using the token.

2. The computer-implemented method of claim 1, wherein determining that the token is valid comprises determining that the digital signature is consistent with the token identifier included in the token certificate.

3. The computer-implemented method of claim 2, wherein the digital signature is generated by a token provider computer, and wherein determining that the token certificate is valid comprises:
hashing, by the access device, a subset of the token certificate including the token identifier to generate a hash of the token certificate;
decrypting, by the access device, the digital signature using a public key of the token provider computer; and
verifying, by the access device, that the decrypted digital signature matches the hash of the token certificate.

4. The computer-implemented method of claim 2, wherein the token certificate further comprises a context identifier that identifies a context in which the token certificate is valid, wherein the method further comprises:
verifying, by the access device, that the context identifier matches an expected value stored on the access device.

5. The computer-implemented method of claim 4, wherein the context identifier is associated with a transit provider, wherein the access device is also associated with the transit provider, and wherein the expected value is a transit provider identifier.

6. The computer-implemented method of claim 5, wherein the access device allows a user associated with the token access to a location upon determining that the token is valid, and wherein the access device conducts the transaction after the user is allowed access to the location.

7. The computer-implemented method of claim 5, further comprising:
sending a signal to actuate a restriction mechanism upon determining that the token is valid, wherein the access device conducts the transaction after the restriction mechanism has been actuated.

8. The computer-implemented method of claim 1, wherein conducting the transaction comprises:
sending, by the access device, an authorization request message for the transaction, the authorization request message including the token; and
receiving, by the access device, an authorization response message, wherein the authorization response message indicates a status of the transaction.

9. A computer-implemented method comprising:
sending, by a user device, a token request to a token provider computer, the token request including account information for a user operating the user device;
receiving, by the user device, a token response from the token provider computer, the token response including a token associated with the account information, and a token certificate associated with the token; and
sending, by the user device, the token and the token certificate to an access device in order to conduct a transaction.

10. The computer-implemented method of claim 9, wherein the token request comprises an account number for a user account, and wherein the token is associated with the account number.

11. The computer-implemented method of claim 9, wherein the token certificate further comprises a context identifier that identifies a context in which the token certificate is valid.

12. The computer-implemented method of claim 11, wherein the context identifier is a transit provider identifier associated with a transit provider, and wherein the token provider computer is associated with the transit provider.

13. An access device comprising:
a processor; and
a non-transitory computer-readable storage medium comprising code executable by the processor for implementing a method comprising:
receiving, from a user device, a token and a token certificate associated with the token, wherein the token certificate comprises a token identifier and a digital signature generated using the token identifier;
determining that the token certificate is valid by verifying the digital signature;
determining that the token is valid using the token certificate; and
conducting a transaction using the token.

14. The access device of claim 13, wherein determining that the token is valid is performed offline.

15. The access device of claim 14, wherein the token certificate further comprises a context identifier that identifies a context in which the token certificate is valid, wherein the method further comprises:
verifying that the context identifier matches an expected value.

16. The access device of claim 15, wherein the context identifier is a transit provider identifier associated with a transit provider, and wherein the token provider computer is associated with the transit provider.

17. The access device of claim 16, wherein the access device allows a user associated with the token access to a location upon determining that the token is valid, and wherein the access device conducts the transaction after the user is allowed access to the location.

18. The access device of claim 13, wherein conducting the transaction comprises:
sending an authorization request message for the transaction, the authorization request message including the token; and
receiving an authorization response message, wherein the authorization response message indicates a status of the transaction.

19. A system comprising:
the access device of claim 13; and
a user device configured to:
send the token and the token certificate to the access device.

20. The system of claim 19, wherein the user device is further configured to:
send a token request to a token provider computer, prior to sending the token and the token certificate to the access device; and
receive a token response from the token provider computer, the token response including the token and the token certificate associated with the token.
